(19) United States
(12) Patent Application Publication
(10) Pub. No.: US 2018/0070544 A1
(43) Pub. Date: Mar. 15, 2018

(54) Direct Water Feed Plant Container

(71) Applicant: Herman Lorenzo Campbell, Charleston, SC (US)

(72) Inventor: Herman Lorenzo Campbell, Charleston, SC (US)

(21) Appl. No.: 15/700,743

(22) Filed: Sep. 11, 2017

Related U.S. Application Data
(60) Provisional application No. 62/495,357, filed on Sep. 12, 2016.

(51) Int. Cl. A01G 27/00; A01G 9/02

(52) U.S. Cl. CPC A01G 27/005; A01G 9/02

(57) ABSTRACT

A container assembly for irrigation of plants comprising: an outer container; an inner container receiving in the outer container, so that an inner container rim and an outer container rim are adjacent; a recess defined between the inner container and the outer container; an internal hose received in the recess, having a portion extending out of the outer container and attached to a subsurface irrigation system, supplying water between 30 psi and 50 psi, to the internal hose; and, a water control cap attached to the internal hose having an output control for controlling the amount of water delivered to an internal area of the inner container.

### BACKGROUND OF THE INVENTION

### 1) Field of the Invention

The present invention relates to a direct feed water system for a plant container, such as a flower pot, that can be integrated into an existing watering system.

### 2) Description of Related Art

Landscaping conventionally uses flower or plant pots for functional and aesthetic purposes. It is a common understanding that the plant in the flower pot needs constant watering else the plant can wither and die. Maintaining a plant in a pot is time consuming and generally requires daily attendance. Therefore, an automatic or watering system that does not require daily maintenance would be advantageous.

There have been many attempts to reduce the watering maintenance of a plant in a pot, including United States Patent Application Publication 2008/0052993, that discloses a flowerpot having an automatic water feed function, comprising an outer pot and an inner pot provided with a water intake hole at the lower portion thereof, wherein the inner pot is detachably fixed in the outer pot and a gap between the inner peripheral surface of the outer pot and the outer peripheral surface of the inner pot constitutes a sealed space that is isolated from the outside air, excepting said water intake hole. The space is used as a water storage section, and the water pooled in the water storage section is gradually supplied to the soil inside the inner pot through the water intake hole.

U.S. Pat. No. 6,584,730 discloses a flowerpot that includes a shoulder adapted to be formed on an inner periphery of the second pot and a watering system provided to be received in the second pot and supported by the shoulder of the second pot. U.S. Pat. No. 1,383,368 is directed to a self-watering flower pot, but still requires water to be placed in the invention periodically. U.S. Pat. No. 2,885,825 discloses a self-watering flower pot with an exterior container to hold water. U.S. Pat. No. 3,043,053 also uses a chamber. U.S. Pat. No. 5,097,626 discloses a watering system for plants growing in a container including a water receptacle above the level of growing medium in the container. The water receptacle may be formed separately from or integrally with the container.

There have also been some attempts to allow water from an irrigation system to be used to water plants in a pot. U.S. Pat. No. 5,617,999 discloses a connector that can be used to place water hoses at specific locations including inserted into the growing medium of a flower pot. U.S. Pat. No. 3,906,667 discloses a constant level irrigation system for watering a potted plant including a vertically moveable reservoir, a pot support for holding the pot so that it extends below the surface of the water in the reservoir and a means for raising or lowering the reservoir to maintain the level of the water in the reservoir constant, independent of the amount of water in the reservoir.

A disadvantage of conventional pots is that these pots are made from plastic or cement or other rigid materials. With exposure to the elements, these pots can deteriorate, break and crack allowing water which would normally be retained in the growing medium to escape, resulting in a dryer than optimal growing environment or requiring unnecessary water.

Accordingly, it is an object of the present invention to provide for a direct feed water system for plant containers that is attached to irrigation systems.

It is another object of the present invention to provide for a direct feed water system for plant containers that is attached to irrigation systems that accounts for irrigation system pressures.

### SUMMARY OF THE INVENTION

The above objectives are accomplished according to the present invention by providing a container assembly for irrigation of plants comprising: an outer container; an inner container receiving in the outer container so that an inner container rim and an outer container rim are adjacent; a recess defined between the inner container and the outer container; an internal hose received in the recess, having a portion extending out of the outer container and attached to a subsurface irrigation system, supplying water between 30 psi and 50 psi, to the internal hose; and, a water control cap attached to the internal hose having an output control for controlling the amount of water delivered to an internal area of the inner container. The inner container rim can extend over the outer container rim. The water control cap can be in fluid communications with a sprinkler head attached to the irrigation system.

An outer bleed opening can be defined in the outer container, and an inner bleed opening defined in the inner container. The inner bleed opening can be in fluid communication with the internal area of the inner container and the outer bleed opening is in fluid communication with the inner bleed opening. The recess can be defined in an outer surface of the inner container. The internal hose can extend out of a side opening defined in the outer container. The water control cap can be affixed to the inner container with water resistance sealant. The water control cap can be affixed to the inner container and disposed above an top ridge, defined in the container.

The container assembly can include a recess defined between the inner container and the outer container; an internal hose received in the recess having a portion extending out of the container and attached to a subsurface irrigation system, supplying water between 30 psi and 50 psi, to the internal hose; and, a water control cap attached to a distal end of the internal hose having an output control for controlling the amount of water delivered to an internal area of the inner container. The container assembly for irrigation of plants comprising: an internal hose disposed inside a side wall of a container; a portion of the internal hose extending out of the container and attached to a subsurface irrigation system, supplying water between 30 psi and 50 psi, to the internal hose; and, a water control cap attached to a distal end of the internal hose, having an output control for controlling the amount of water delivered to an internal area of the inner container.

### BRIEF DESCRIPTION OF THE DRAWINGS

The construction designed to carry out the invention will hereinafter be described, together with other features thereof. The invention will be more readily understood from reading the following specification and by reference to the accompanying drawings forming a part thereof, wherein an example of the invention is shown and wherein:

FIG. 1 is a perspective view of aspects of the invention;

FIG. 2 is a perspective view of aspects of the invention;

FIGS. 3A and 3B are perspective views of aspects of the invention; and,

FIGS. 4A and 4B are perspective views of aspects of the invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above, in conjunction with the accompanying examples, data, figures, and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

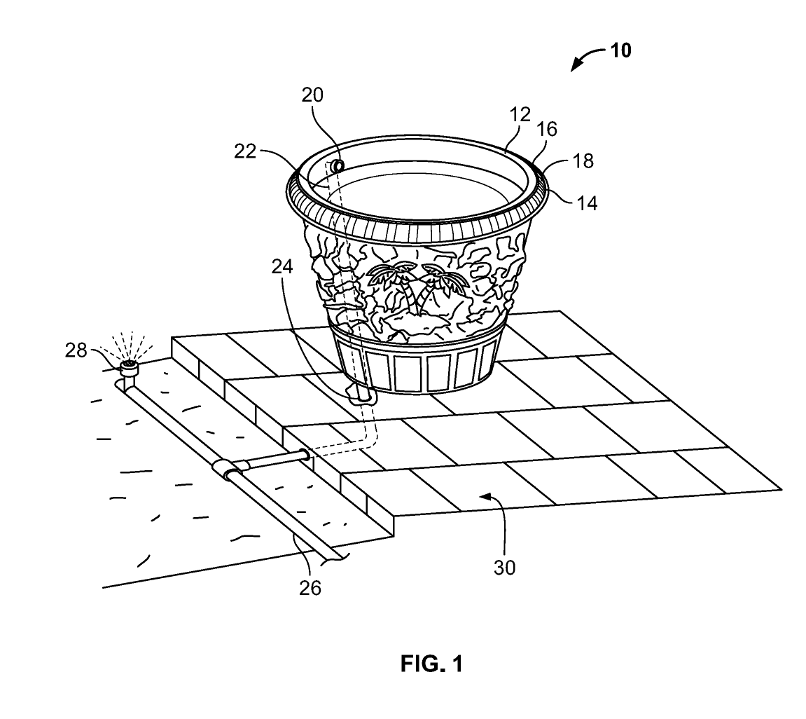

FIG. 1 shows a container assembly 10 having an inner container 12 and an outer container 14. The outer container can be a conventional container made from rigid materials such as plastic, cement or the like. The outer container can include a decorative outer surface. The inner container is configured to be disposed within the outer container so that the top of the inner container can be flush with the top of the outer container. An inner container rim 16 of the inner container can be adjacent to an outer container rim 18 so that there is little or no gap between these rims. The growing medium, such as soil, is placed in an internal area defined in the inner container and the plant is then placed in the growing medium.

A water control cap 20 is attached to an internal hose 22. The water control cap can be adjusted to regulate the amount of water flowing through the internal hose, and into the growing medium. The water control cap can include a nozzle and a cap cooperatively associated so that when the cap to positioned in one position, water is restricted from the nozzle and what the cap is position in another position, water can freely flow from the nozzle. The amount of restriction applied can be adjusted by the placement of the cap on the nozzle.

By regulating the amount of water that flows through the water control cap, the water pressure from the irrigation system can be effected so when two or more container assembles are attached to an irrigation system, the water delivered to the water control caps can reduce the water pressure of the irrigation system. Therefore, the irrigation system can be configured to be in zones wherein a first zone could have a first combination of water control cap and sprinkler heads and a second zone has another combination of water control caps and sprinkle heads to balance the water pressures among the zones.

The internal hose can be disposed between the inner container and the outer container. In one embodiment, the internal container can include a recess for receiving the internal hose allowing the internal container to be received in the outer container without the hose interfering with the fit between the internal container and the outer container. In one embodiment, the outer container can include a recess for receiving the internal hose, allowing the internal container to be received in the outer container, without the hose interfering with the fit between the internal container and the outer container.

The internal hose can extend through the bottom of the outer container, inner container or combination so that the internal hose includes a lower portion 24 that is external to the outer container. This portion can be attached to an irrigation system 26 so that water can be supplied to the internal hose, water control cap and growing medium from the irrigation system. The irrigation system can be subsurface. The irrigation system can include other attachments such as sprinkler heads 28. One advantage of having the internal hose attached to the irrigation system, that also includes sprinkler heads, is that the water pressure of the irrigation system is not all directed to the water control cap, reducing the strain on the inner hose and water control cap. The irrigation system can be disposed under a patio 30, deck or the like so that the irrigation system and internal hose are not visible providing for an aesthetically pleasing watering system for pots. By attaching the internal hose to an existing irrigation system, the water pressures of the irrigation system can be dispersed between the sprinkler heads and the water control cap. In this configuration the water control cap and the sprinkler heads can be in fluid communication. Otherwise, the pressure of the irrigation system, typically 30 psi to 50 psi, will over pressure the water control cap and cause the water control cap to mist or fog preventing water from properly entering the growing medium.

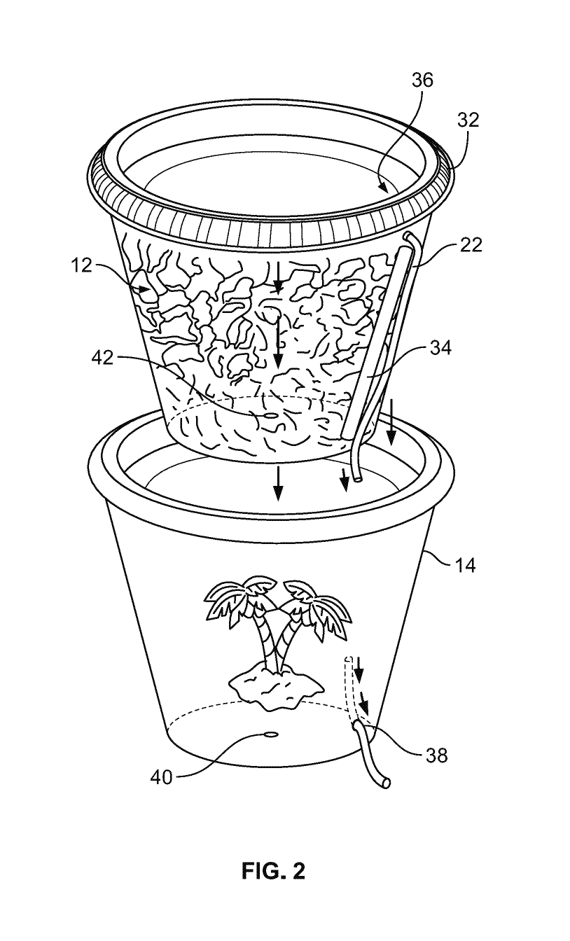

Referring to FIG. 2, the inner container can be placed in a preexisting container so that the preexisting container becomes the outer container allowing the use of conventional planters or pots. The inner container 12 can include a top edge 32 that can extend over the top of the outer container so that the gap between the outer container and the inner container is disposed beneath the top edge of the inner container. In this embodiment, rainwater, debris and other items cannot as easily fall between the inner container and the outer container. The inner container includes an internal hose 22 that extends through the inner container at the top of the inner container and is attached to the water control cap disposed at location 36. The internal hose can be received by a recess 34 allowing the inner container to more easily be received in the outer container. The internal hose can extend through the outer container 14 either at a side opening 38 or a bottom opening. The portion of the internal hose extending from the outer container can be attached to an irrigation system to supply water that can be dispensed through the water control cap. An outer bleed opening 40 can be defined in the bottom of the outer container so that water escaping the inner container through an inner bleed opening 42 can be expelled out of the outer container.

In one embodiment, the inner container is a resilient material, such as rubber, that can be compressed so that it can be received by the outer container. When the inner container is compressed to be placed in the outer container, the inner container can expand to fill the outer container so that the cavity defined in the inner container is maximized to receive the growing medium. Further, if the outer container cracks, breaks or is otherwise damaged, the inner container can hold the growing medium and water preventing the plant from being damaged by the failed outer container.

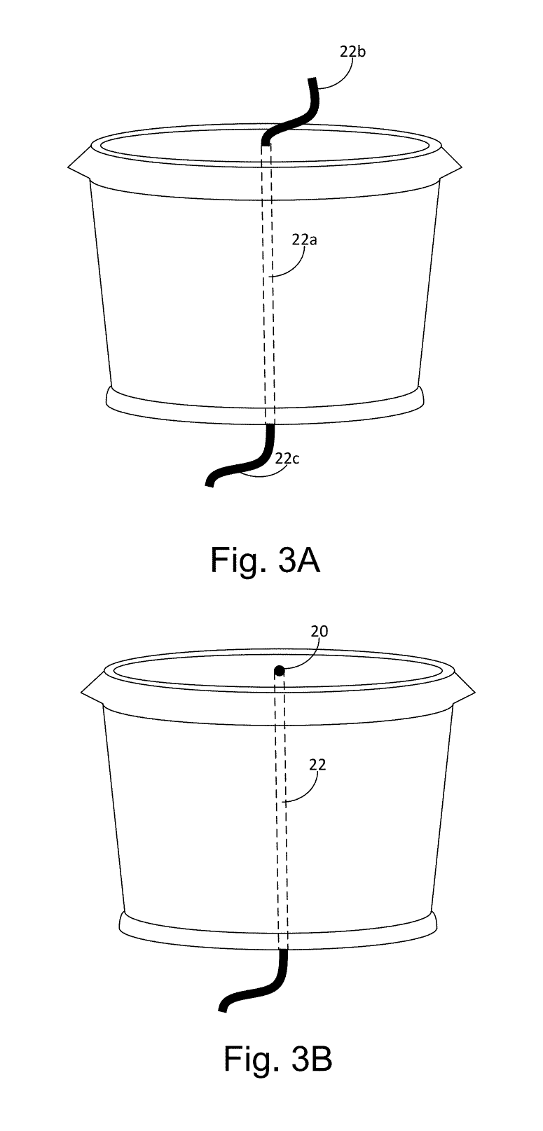

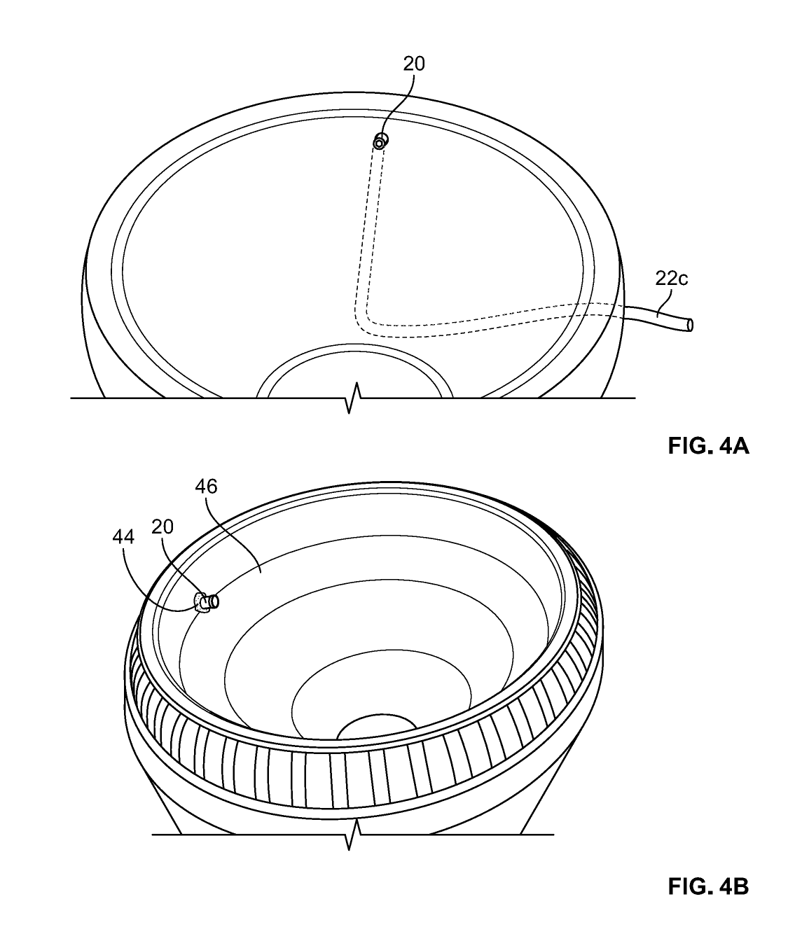

Referring to FIGS. 3A and 3B, the inner hose can be manufactured into the container. In this embodiment, the inner hose is positioned in the mold and cement, plastic or other material is placed in the mold to form the container. When the container is formed and hardens, the inner hose has an inner portion 22a that is disposed in the container material with a distal end 22b extending from generally the top of the container and a proximal end 22c extended generally from the bottom of the lower side of the container. When manufactured, the distal end can be trimmed and the water control cap 20 can then be attached to the distal end and secured to the container. The proximal end of the inner hose can be attached to a water source such as an irrigation system. Referring to FIG. 4A, the container is shown manufactured from concrete, with the water control cap 20 attached to the inner hose at generally the top inner surface of the container. The inner hose can extend out of the container and connect at its proximal end 22c to a water supply. Referring to FIG. 4B, the water control cap is shown secured to the inner surface of the container. Sealant 44 can be used to secure the water control cap to the container as well as to provide water resistance to prevent water from entering any spaces around the inner hose or recess. The water control cap can be disposed above the top ridge 46 defined in the inner surface of the container.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases, in some instances, shall not be read to mean that the narrower case is intended or required in instances where such broadening phrases may be absent.

While the present subject matter has been described in detail with respect to specific exemplary embodiments and methods thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A container assembly for irrigation of plants comprising:
an outer container;
an inner container receiving the outer container so that an inner container rim and an outer container rim are adjacent;
a recess defined between the inner container and the outer container;
an internal hose received in the recess, having a portion extending out of the outer container and attached to a subsurface irrigation system, supplying water between 30 psi and 50 psi, to the internal hose; and,
a water control cap attached to the internal hose having an output control for controlling the amount of water delivered to an internal area of the inner container.

2. The container assembly of claim 1 wherein the inner container rim extends over the outer container rim.

3. The container assemble of claim 1 wherein the water control cap is in fluid communications with a sprinkler head attached to the irrigation system.

4. The container assembly of claim 1 including:
an outer bleed opening defined in the outer container;
an inner bleed opening defined in the inner container; and,
wherein the inner bleed opening is in fluid communication with the internal area of the inner container and the outer bleed opening is in fluid communication with the inner bleed opening.

5. The container assembly of claim 1 wherein the recess is defined in an outer surface of the inner container.

6. The container assembly of claim 1 wherein the internal hose extends out of a side opening defined in the outer container.

7. The container assembly of claim 1 wherein the water control cap is affixed to the inner container with water resistance sealant.

8. The container assembly of claim 1 wherein the water control cap is affixed to the inner container and disposed above a top ridge defined in the container.

9. A container assembly for irrigation of plants comprising:
a recess defined between an inner container and an the outer container included in the container assembly;
an internal hose received in the recess having a portion extending out of the container assembly and attached to a subsurface irrigation system, supplying water between 30 psi and 50 psi, to the internal hose; and,
a water control cap attached to a distal end of the internal hose having an output control for controlling the amount of water delivered to an internal area of the inner container.

10. The container assemble of claim 9 wherein the water control cap is in fluid communication with a sprinkler head attached to the irrigation system.

11. The container assembly of claim 9 including an outer bleed opening defined in the container wherein the outer bleed opening is in fluid communication with the internal area of the container.

12. The container assembly of claim 9 wherein the internal hose extends out of a side opening defined in the container.

13. The container assembly of claim 9 wherein the water control cap is affixed to the container with water resistance sealant.

14. The container assembly of claim 9 wherein the water control cap is affixed to the inner container and disposed above a top ridge defined in the container.

15. A container assembly for irrigation of plants comprising:
an internal hose disposed inside a side wall of a container;
a portion of the internal hose extending out of the container and attached to a subsurface irrigation system, supplying water between 30 psi and 50 psi, to the internal hose; and,
a water control cap attached to a distal end of the internal hose having an output control for controlling the amount of water delivered to an internal area of the inner container.

16. The container assemble of claim 15 wherein the water control cap is in fluid communication with a sprinkler head attached to the irrigation system.

17. The container assembly of claim 14 including an outer bleed opening defined in the container wherein the outer bleed opening is in fluid communication with the internal area of the container.

18. The container assembly of claim 15 wherein the internal hose extends out of a side opening defined in the container.

19. The container assembly of claim 15 wherein the water control cap is affixed to the container with water resistance sealant.

20. The container assembly of claim 15 wherein the water control cap is affixed to the inner container and disposed above a top ridge defined in the container.
